(19) United States
(12) Patent Application Publication
(10) Pub. No.: US 2015/0054483 A1
(43) Pub. Date: Feb. 26, 2015

(54) LOAD BANK PROVIDING CONSTANT POWER

(71) Applicant: Experium Technologies, LLC, Upper Marlboro, MD (US)

(72) Inventor: Lance Palatini, Morris Plains, NJ (US)

(73) Assignee: Experium Technologies, LLC, Upper Marlboro, MD (US)

(21) Appl. No.: 13/970,737

(22) Filed: Aug. 20, 2013

(51) Int. Cl. G05F 1/12

(52) U.S. Cl. CPC G05F 1/12
USPC 323/293

(57) ABSTRACT

An adjustable load bank provides a load to a power source that is able to maintain a constant power and constant current as well as power factor control. The load bank utilizes various resistive and inductive elements that may be connected or disconnected as required. In operation, the load bank continuously monitors the voltage and current across the resistive and inductive elements and applies or subtracts elements as necessary via control signals in order to maintain the desired fixed total power dissipated by the load bank.

### BACKGROUND OF THE INVENTION

A load bank system is often used to provide an electrical load for the testing of alternating current (“AC”) power sources such as power inverters and AC voltage generators. The load bank may include multiple resistive and/or inductive elements that can be individually connected in parallel to achieve a desired initial load.

However, in various testing procedures it is often advantageous to maintain a constant power load on an electrical power source despite changes in the voltage applied to the load bank by the power source. Accordingly, there is a need for a load bank that is able to adjust the resistive or inductive elements that are connected in order to respond to changes in the applied voltage at the load bank's input terminals.

### BRIEF DESCRIPTION OF THE PRIOR ART

Load bank systems are known in the prior art. For example, U.S. Pat. No. 5,424,588 to Cantor et al. discloses a load bank for use with DC power supplies that utilizes wire wound resistors with taps that can selectively control the current flow through the resistors. U.S. Patent Application Publication No. 2005/0134248 to Locker et al. discloses a load bank system that utilizes high speed solid state electronic circuitry that rapidly switches according to a duty cycle command in order to sequentially permit and prevent current flow through a resistor.

While the prior load banks provide certain control over characteristics of electrical load provided by the load bank, they do not provide a load bank that is able to adjust the resistive or inductive elements that are connected in order to maintain constant power in response to changes in the applied voltage at the load bank's input terminals. The present invention was developed in order to overcome these and other drawbacks of the prior load banks.

### SUMMARY OF THE INVENTION

Accordingly, it is a primary object of the invention to provide a load bank that is able to adjust the resistive or inductive elements that are connected to the load circuit in order to maintain constant power in response to changes in the applied voltage at the load bank's input terminals. Such a load bank in accordance with embodiments of the present invention includes a positive input terminal connected with a positive terminal of the power source and a negative input terminal connected with a negative terminal of the power source. The load bank further includes a resistive path connecting the positive and negative input terminals. At least one resistive element is placed in the resistive path with a switch connected in series with the resistive element. The switch operates to selectively connect or disconnect the resistive element from the resistive path. The load bank also includes an inductive path connecting in parallel with the resistive path. At least one inductive element is placed in the inductive path with a switch in series with the inductive element to selectively connect or disconnect the inductive element.

Further embodiments of the load bank include a measurement system for measuring a voltage across the input terminals as well as the current through the resistive path and the current through the inductive path. Embodiments of the load bank may also include a control system for controlling actuation of the switches and a control module that collects measurement data from the measurement system and in response, sends control signals to the control system.

### BRIEF DESCRIPTION OF THE FIGURES

Other objects and advantages of the invention will become apparent from a study of the following specification when viewed in the light of the accompanying drawing, in which:

FIG. 1 is a diagram of a power triangle showing the relationship between total power, resistive power and inductive power in a load bank in accordance with embodiments of the present invention; and

FIG. 2 is a circuit diagram of a load bank in accordance with embodiments of the present invention.

### DETAILED DESCRIPTION

In an embodiment of the present invention, an adjustable load bank provides a load to a power source that is able to maintain constant power and constant current as well as power factor control. The load bank utilizes various resistive and inductive elements that may be connected or disconnected as required.

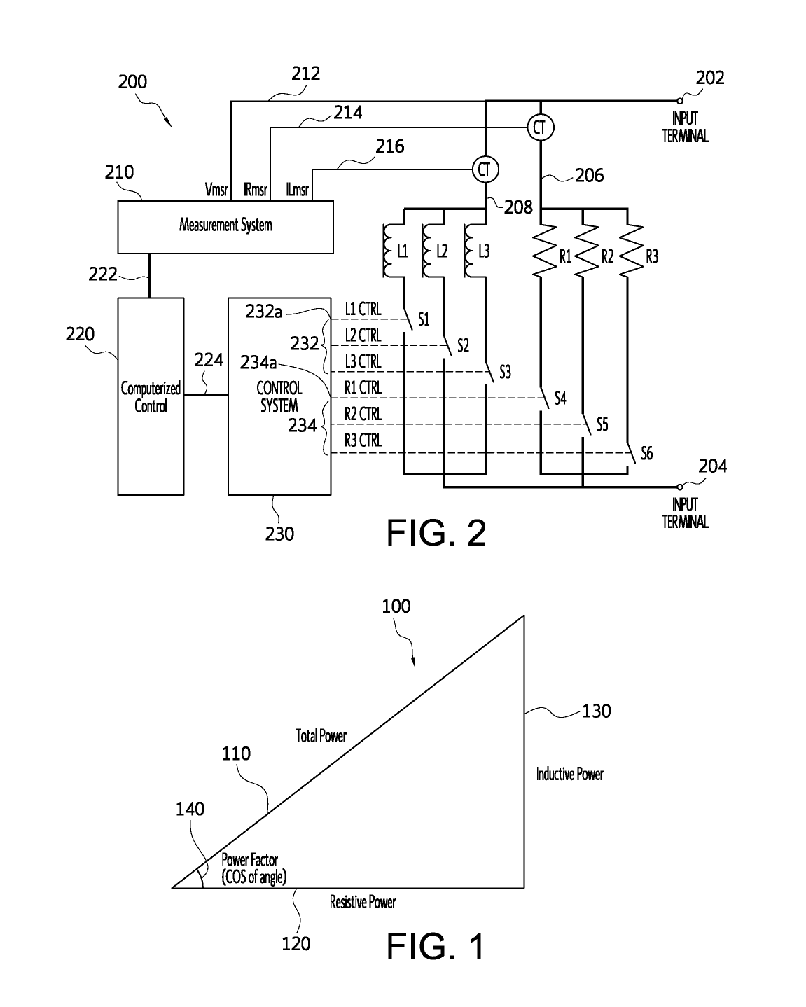

As shown in FIG. 1, the relationship among the total power (Pₜₒₜₐₗ), resistive power (Pᵣₑₛᵢₛₜ) and power (P_{induct}) in an AC load bank can be understood with reference to a power triangle 100. In the power triangle, the length of the hypotenuse 110 represents the total power, also referred to as the apparent power, dissipated by a load bank applied to an AC power source. The base leg 120 represents the resistive power component of the load, which may be referred to as the real power. The vertical leg 130 represents the inductive power component, also referred to as the reactive power. Accordingly, the total power, measured in Volt-Amps (VA), may be determined by the following equation:

Pₜₒₜₐₗ=\sqrt{Pᵣₑₛᵢₛₜ²+P_{induct}²} [VA] [Eq. ]

The power factor (PF) can also be determined with reference to the power triangle 100 as the cosine of the angle 140. The power factor can be expressed by the equation:

$$PF = {P}_{resist} \text{/} {P}_{induct} \qquad [ Eq . 2 ]$$

In the above equation Eq. 2, the resistive power (Pᵣₑₛᵢₛₜ) is a function of the applied voltage (V_{applied}) and the resistance (R) of a circuit in accordance with the following equation, where the applied resistive power is measured in Watts (W):

$${P}_{resist} = {V}_{applied}^{2} \text{/} R [ W ] \qquad [ Eq . 3 ]$$

The inductive power (P_{induct}) in Equation 2, in turn, is a function of the applied voltage (V_{applied}) and the inductance (L) of the circuit and is measured in Volt-Amps-Reactive (VAR) as shown in Equation 4:

$${P}_{induct} = {V}_{applied}^{2} \text{/} XL \\ where \\ XL = 6.28 * L [ VAR ] \qquad [ Eq . 4 ]$$

As explained above, the resistive power, inductive power and total power are functions of the applied voltage. It therefore follows that these measurements will vary with changes in the applied voltage. In embodiments of the invention, a load bank is provided that can maintain a constant power load on an electrical power source by continuously monitoring the applied voltage and adjusting the resistive and inductive elements as required.

As shown in FIG. 2, an exemplary load bank 200 includes a positive input terminal 202 and a negative input terminal 204 for connecting to positive and negative terminals of an AC power source. A first resistive path 206 connects the positive input terminal 202 with the negative input terminal 204. The resistive path comprises a first resistive element, which may be a resistor R1, and may include additional resistors R2, R3 in parallel with the first resistor R1. Three such resistors are shown, but one of ordinary skill in the art will understand that the number and characteristics of the resistors may vary depending upon the desired load, rating, resolution and other factors.

The load bank 200 may also comprise an inductive path 208 connecting the positive input terminal 202 with the negative input terminal 204 in parallel with the resistive path 206. The inductive path comprises a first inductive element, which may be an inductor L1, and may include additional inductors L2, L3 in parallel with the first inductor L1. Again, while three such inductors are shown, it should be understood that the number and characteristics of the inductive elements may vary as would be apparent to one of ordinary skill in the art.

As further illustrated in FIG. 2, embodiments of the load bank comprise a measurement system 210. The measurement system includes a first lead 212 connected to the input terminal 202 so that the measurement system is capable of measuring the voltage (Vmsr) across the positive input terminal 202 and the negative input terminal 204. The measurement system further includes a second lead 214 connected to the resistive path 206 that allows the measurement system to measure the current (IRmsr) through the resistive path. The measurement system also includes a third lead 216 connected to the inductive path 208 that allows the measurement system to measure the current (ILmsr) through the inductive path.

The measurement system 210 may include sensors and other components for measuring voltage and current as would be apparent to one of ordinary skill in the art. The measurement system may further include a microprocessor and memory that allow the measurement system to periodically and repeatedly collect measurements of the voltage (Vmsr), resistive current (IRmsr) and inductive current (ILmsr).

The load bank 200 may further include a computerized control module 220 with a data bus 222 connecting the measurement system 210 with the control module 220. The data bus 222 is used to communicate information regarding the voltage and current measurements conducted by the measurement system. A second data bus 224 connects the control module 220 with a control system 230.

As further illustrated in FIG. 2, the control system 230 may include a first set of outputs 232. In the exemplary embodiment, a first output 232a is connected to a first switch Si that is connected in series with the first inductive element L1. Using this output, the control system may send a signal L1 CTRL that causes the switch Si to connect and disconnect the inductive element L1 from the circuit. Other outputs are correspondingly connected to send signals to additional switches S2, S3, which are connected in series with the additional inductive elements L2, L3, respectively. Accordingly, by controlling the signals sent on outputs 232, the control system may vary the number and arrangement of inductors applied across the load bank terminals 202, 204.

The control system 230 may include a second set of outputs 234 connected to switches that are in turn connected in series with resistive elements of the resistive path 206. In the exemplary embodiment, a first output 234a is connected to a first switch S4 that is in series with the first resistive element R1. As with the inductive elements, the control system may send a signal R1 CTRL that causes switch S4 to connect and disconnect the resistive element R1 from the circuit. Other outputs are correspondingly connected to send signals to additional switches S5, S6, which are connected in series with the additional resistive elements R2, R3, respectively. The control system may thereby also vary the number and arrangement of resistors applied across the load bank terminals 202, 204.

The switches S1-S6 may be relays that are activated by signals sent from outputs 232, 234. In particular, the switches may be contactors appropriate for use in AC power systems. The control system 230 may include electrical and other components such as microprocessors and memory that enable it to convert input received from the control module 220 into signals that can control the activation of switches S1-S6.

In operation, the exemplary load bank shown in FIG. 2 continuously monitors the voltage and current across the resistive and inductive elements R1, R2, R3, L1, L2, L3 and applies or subtracts elements as necessary via the control signals R1 CTRL, R2 CTRL, R3 CTRL, L1 CTRL, L2 CTRL, L3 CTRL in order to maintain the desired fixed total power dissipated by the load bank. The control module 220 includes a microprocessor that may be programmed to perform the associated calculations, as discussed above, such that certain performance characteristics can be achieved even with fluctuations in applied voltage. The performance characteristics that may be controlled by thus adjusting the combination of active resistive and inductive elements in load bank include: (1) constant resistive power, (2) constant inductive power, (3) constant total power, (4) constant resistive current, (5) constant reactive current, and (6) constant total current. Additionally the system is capable of providing and maintaining an adjustable power factor by measuring the resistive power (equal to Vmsr*IRmsr) and the inductive power (equal to Vmsr*ILmsr) and adjusting the applied elements as necessary.

While the preferred forms and embodiments of the invention have been illustrated and described, it will be apparent to those of ordinary skill in the art that various changes and modifications may be made without deviating from the inventive concepts set forth above.

What is claimed is:

1. A load device for applying a load on a power source, comprising
(a) a positive input terminal connected with a positive terminal of the power source;
(b) a negative input terminal connected with a negative terminal of the power source;
(c) a resistive path connecting said positive input terminal with said negative input terminal including at least one resistive element and a first switch connected in series with said resistive element, said first switch being operable to selectively connect or disconnect said resistive element from said resistive path; and
(d) an inductive path connecting said positive input terminal with said negative input terminal in parallel with said resistive path including at least one inductive element and a second switch connected in series with said inductive element, said second switch being operable to selectively connect or disconnect said inductive element from said inductive path.

2. The load device of claim 1, and further comprising a measurement system measuring a voltage across said positive input terminal and said negative input terminal.

3. The load device of claim 2, wherein said measurement system measures a current through said resistive path.

4. The load device of claim 3, wherein said measurement system measures a current through said inductive path.

5. The load device of claim 2, and further comprising a control module and a data bus connecting said measurement system to said control module.

6. The load device of claim 1, and further comprising a control system including a first output connected to said first switch.

7. The load device of claim 6, wherein said control system sends a first signal for actuating said first switch to selectively connect or disconnect said resistive element from said resistive path.

8. The load device of claim 6, wherein said control system further comprises a second output connected to said second switch.

9. The load device of claim 8, wherein said control system sends a second signal for actuating said second switch to selectively connect or disconnect said inductive element from said resistive path.

10. The load device of claim 1, wherein said first switch is a relay.

11. The load device of claim 10, wherein said relay is a contactor.

12. The load device of claim 5, and further comprising a control system and a second data bus connecting said control system to said control module.

13. The load device of claim 12, wherein said control module receives measurement data from said measurement system and sends input signals to said control system in response to said measurement data.

14. A load device for applying a load on a power source, comprising
(a) a resistive path connecting a positive input terminal with a negative input terminal, including
(1) a first resistive element; and
(2) a first switch connected in series with said resistive element;
(b) an inductive path connecting said positive input terminal with said negative input terminal in parallel with said resistive path, including
(1) a first inductive element; and
(2) a second switch connected in series with said resistive element;
(c) a measurement system measuring a voltage across said positive input terminal and said negative input terminal; and
(d) a control system including a first output connected to said first switch and a second output connected to said second switch.

15. The load device of claim 14, wherein said control system sends a first signal for actuating said first switch to selectively connect or disconnect said first resistive element from said resistive path.

16. The load device of claim 14, and further comprising at least one additional resistive element and at least one additional switch connected in series with said additional resistive element.

17. The load device of claim 15, wherein said control system sends a second signal for actuating said second switch to selectively connect or disconnect said first inductive element from said inductive path.

18. The load device of claim 14, and further comprising at least one additional inductive element and at least one additional switch connected in series with said additional inductive element.

19. The load device of claim 14, wherein said first switch is a first relay and said second switch is a second relay.

20. The load device of claim 19, wherein said first relay is a first contactor and said second relay is a second contactor.
